(19) United States
(12) Patent Application Publication
(10) Pub. No.: US 2007/0112662 A1
(43) Pub. Date: May 17, 2007

(54) Profiling the investment style of institutional investors

(76) Inventor: Prem Kumar, Croydon (GB)

Correspondence Address: Paul E Schaafsma;NovusIP, LLC, Suite 221, 521 West Superior Street, Chicago, IL, 60610-3135, US

(21) Appl. No.: 11/271,232

(22) Filed: Nov. 12, 2005

(51) Int. Cl. G06Q 40/00

(52) U.S. Cl. 705/36 R

(57) ABSTRACT

The present invention provides a method of profiling institutional investors. In accordance with the principles of the present invention, the pseudo portfolio is created to see how an investor has behaved given a choice between a value and a growth stock. The investor's historical portfolio is filtered through the pseudo portfolio and the aggregate on the style and sector dimensions are sliced. This helps determine the value-growth preference of the investor and can be quantified as well in percentage terms.

### FIELD OF THE INVENTION

The present invention relates to profiling investors.

### BACKGROUND OF THE INVENTION

As the volume and type of information available overloads the capacity to absorb it, information asymmetry or distortion poses a major problem for all the participants of today's financial markets. These problems have their origin in the way the financial markets have evolved over the last five decades.

A p1952 publication by Markowitz changed the way investors analyse and construct their portfolios using a few statistical components. (Markowitz, H., “Portfolio Selection”, Journal of Finance, 7(1), 77-92 (1952)). Prior to Markowitz's publication, investors focused on assessing the risks and rewards of individual securities in constructing their portfolios. Markowitz's efficient frontier was a way of visually and statistically arriving at a set of optimal portfolios that matched the risk preference of the investor.

The subsequent introduction of the capital asset pricing model by Sharpe resulted in the sacrosanct status that was granted to beta (β), a measure of stock's volatility using the slope from the regression analysis. (Sharpe, W. F., “Capital Asset Prices: a Theory of Market Equilibrium under Conditions of Risk”, Journal of Finance, 19(3), 425-443 (1964)). The capital asset pricing model measures risk of an asset by the covariance of the asset's return with the market return, which in empirical studies is proxied by a diversified portfolio of common stocks such as the S&P 500®. The capital asset pricing model was seen as an ignition key to the time machine that investors could use in arriving at expected returns.

One of the main criticisms of the capital asset pricing model is that it does not take into account the marginal utility of investors and assumes that all investors have the same risk preference thereby making the investor external to the equation. (Merton, R. C, “An Intertemporal Capital Asset Pricing Model”, Econometrica, 41(5), 867-889 (1973)). The most serious criticism of capital asset pricing model came from Fama and French, who demonstrated that the risk of a stock, measured by beta, was not a reliable predictor of performance (i.e. knowing the beta of a stock does not tell you much about the future return of that stock). (Fama, E. F. and French, K., “The Cross-Section of Expected Stock Returns”, Journal of Finance, 47(2), 427-467 (1992)).

A 1970 publication by Fama caused a lot of debate in the investment and academic world. (Fama, E. F., “Efficient Capital Markets: a Review of Theory and Empirical Work”, Journal of Financial Economics, 25(2), 383 (1970)). The efficient market hypothesis describes the capital markets as being frictionless when it comes to information dissemination and that the security prices fully and correctly reflect all available information. Any change to this price is brought about only by the flow of new information. While the efficient market hypothesis acknowledges that the prices tend to deviate from their fair value, these are supposedly random events or “random walks,” and the prices will eventually move back to their fair value. But by this very admission of the deviation, efficient market hypothesis has undermined the basic premise on which it stands (i.e. that information is reflected immediately in the market).

Since information is reflected in the market almost instantaneously, according to the efficient market hypothesis, no one investor enjoys an advantage over the information. An investor would be able to beat the market only during the “random walks” and cannot do so consistently. If an investor happens to beat the market consistently, it is more out of luck than skill. This brings to mind the legendary investor Warren Buffet, whose company, Berkshire Hathaway, generated an annualised return of 26.18 percent during a 35 year period, more than double the 11.69 percent of S&P 500® index. (Statman, M. and Scheid, J., “Buffett in Foresight and Hindsight”, Financial Analysts Journal, 58(4), 11-19 (2002)). The S&P 500® index is a capitalisation weighted index of 500 U.S. companies disseminated by Standard & Poor's, 55 Water Street, New York, N.Y. 10041 (“S&P”).

According to Buffet, the teachings of the efficient market hypothesis to students and investment professionals has been an extraordinary service to investors like him as it turned these professionals into gullible investors and helped him stay ahead of others. (Hagstrom, R. G., The Warren Buffet Portfolio: Focus Investment Strategies of the World's Greatest Investor, Chichester, UK: John Wiley & Son Ltd. (1999)). The adverse impact and influence of noise trading on other market participants are explained in numerous studies. (Barberis, N. and Shleifer, A., “Style Investing”, Journal of Financial Economics, 68(2), 161-199 (2003); DeLong, J. B., Shleifer, A., Summers, L. H. and Waldmann, R. J., “Noise Trader Risk in Financial Markets”, Journal of Political Economy, 98(4), 703-739 (1990)). Noise can have adverse influence on “rational” investors by keeping the prices away from their mean value even after discounting the “irrational” traders, forcing the rational investors to act as if their horizon is short due to pressure from their customers. Since one cannot beat the market, the efficient market hypothesis also proposed investing in an index. While there are significant advantages in index investing such as low turnover and low overhead (Laderman, J. M., “Index Investing: The Joys of Flying on Autopilot”, Business Week, June 1997, 128-132), it did not mean that there were no investors who could beat the market consistently.

Critics of the efficient market hypothesis demonstrated time and again that what was described as a “random walk” was not random after all. Critics have come up with many anomalies that disproved the efficiency of the markets including: The Monday effects in which the presence of a systematic trading pattern of investors related to Mondays makes it difficult to reconcile such patterns with the explanations of randomness in the efficient market hypothesis (Abraham, A. and Ikenberry, D., “The Individual Investor and the Weekend Effect”, Journal of Financial & Quantitative Analysis, 29(2), 263-278 (1994)); the size effect in which the risk adjusted returns of smaller companies remained higher, on average, than large companies while efficient markets, going by efficient market hypotheses, should have increased the prices of these (smaller) stocks to their true value (Banz, R., “The Relationship between Return of Theory and Market Value of Common Stocks”, Journal of Financial Economics, 9(1), 3-18 (1981)); S&P index inclusion in which the prices of stocks included in the S&P 500® index increased significantly immediately after the announcement of the inclusion, only to be reversed in two weeks (Harris, L. and Gurel, E. “Price and Volume Effects Associated with Changes in the S&P 500 List: New Evidence Existence of Price Pressures”, Journal of Finance, 41(4), 815-830 (1986),); and the weather effect, which demonstrated that sunshine was significantly correlated with stock returns (Hirshleifer, D. and Shumway, T., “Good Day Sunshine: Stock Returns and the Weather”, Journal of Finance, 58(3), 1009-1035 (2003)). Inclusion in S&P 500® index is based not on forecasted security return, but on publicly available information and well-known criteria, which does not qualify as new information. The subsequent reversal of share price implies that it takes two weeks for the price to return to its fundamental value. An explanation of the effect that the weather influenced the mood of the investor, which in turn was reflected in the prices, cannot be reconciled with the efficient market hypothesis's idea of efficient markets. According to the efficient market hypothesis, new information is the key agent for change.

Surprisingly, the arguments about information asymmetry are valid even to this day, in spite of the increasing reliance on computer systems in the financial markets that make the exchange of information almost instantaneous. The reason for this is not the speed of information flow, but the quality of such information. The fact that the final decision to buy or sell is made by humans explains much of the information asymmetry.

Nevertheless, these modern portfolio theories did change the way investors looked at portfolios as being a collection of stocks. It replaced the earlier belief that the risk of an individual security could be measured on the basis of the properties of its simple probability distribution, without regard to its relationships with other securities. (Haugen, R. A., Modern Investment Theory, 5^{th} ed., New Jersey, U.S.: Prentice Hall (2001)). The sum of parts was not necessarily the same as the whole. The popularity of the capital asset pricing model was due to its ease in computing once its underlying assumptions are accepted. This resulted in the technique becoming a major analytical tool for investors across the world. It also offered a framework for understanding and generalising market movements. (Nicolaou, M. A., The Theory and Practice of Security Analysis, Basingstoke, UK: Macmillan (2000)).

More recent then these modern portfolio theories, which start with the idea of a rational agent, behavioural finance starts on the premise that the “rational man” does not exist. (Van Der Sar, N., “Behavioral Finance: How Matters Stand?” Journal of Economic Psychology, 25(3), 425-444 (2004)). Behavioural theorists claim that the so-called randomness of the efficient market theories is nothing but the presence of irrational agents who cause the security prices to deviate from their fundamental values. Clowes argues that if the markets were efficient, there was no need for many to seek active management returns. (Clowes, M., “New Behavioral Market Theory”, Pensions & Investments 33(3), 12-13 (2005)).

Behavioural finance theories argue that these phenomena can be understood better by using models in which some agents are not fully rational. (Barberis, N. and Shleifer, A., “Style Investing”, Journal of Financial Economics, 68(2), 161-199 (2003)). Investors generally make choices that are merely satisfactory, not necessarily optimal. This is due to the limitation on resources and computational capabilities. To overcome these limitations, investors use shortcuts and past experiences, and this introduces behavioural biases. Investors are therefore satisfied in finding a solution that is good enough, if not optimal. (Simon, H. A., “A Behavioral Model of Rational Choice”, Quarterly Journal of Economics, 69(1), 99-119 (1955)). Goetzmann and Peles describe this as being one of the greatest mysteries in the mutual fund industry, who are quick to pour money into funds that are winners, but are reluctant in withdrawing from funds that consistently perform poorly. (Goetzmann, W. and Peles, N., “Cognitive Dissonance and Mutual Fund Investors, Journal of Financial Research”, 20, 145-58 (1997)). While high switching costs can be one of the reasons for this, past experience does play a dominant role in such decisions and overrides rationality, influencing the investor to discount the actual performance. Professional money managers routinely mimicked their peers while constructing or rebalancing their portfolios, exhibiting herd behaviour. (Chernoff, J., “Money Managers Mimic Neighbors”, Pensions & Investments 32 (3), 3-5 (2004)).

Anxiety affects the decision-making process, often forcing investors to look at the small pieces instead of the big picture, making them susceptible to rumours, tips, and headlines. The risk tolerance calculated by sophisticated asset allocation programs does not take these feelings into consideration, rendering the results nearly worthless. (Geist, R. A., “Investors Behaving Badly”, On Wall Street, 13(5), pag (2003)). Information asymmetry also results from the level of access different investors have over information that is not yet in the public domain. While some analysts and large institutional investors have access to top management of companies they follow, thus giving them an informational advantage, other investors who do not have this level of access may have to fill this (information) gap based on past results and experiences. (Jacob, J., Lys, T. Z. and Neale, M. A., “Expertise in Forecasting Performance of Security Analysts”, Journal of Accounting & Economics, 28(1), 51-83 (1999)).

While many critics of behavioural theories see it as a “catch all” container for any phenomenon that cannot be explained by modern portfolio theory, behavioural theories nevertheless brought some fresh air into the investment world, which was obsessed with modern portfolio theory. To assume that the market had perfect information and that all investors behaved rationally was naïve. Behavioural finance should be used to understand the human factor in the analysis of financial markets instead of being considering a separate field brought in to focus solely on scenarios that depart from expected rational behaviour. (Van Der Sar, N., “Behavioral Finance: How Matters Stand?” Journal of Economic Psychology, 25(3), 425-444 (2004)). With the growing recognition of the behavioural finance, heavyweight investors such as JPMorgan, 522 Fifth Avenue New York, N.Y. 10036 U.S.A. and ABN AMRO, 101 Sabin Street, Pawtucket, R.I. 02860 U.S.A. are now running behavioural mutual funds. (Rutter J., “Behaviouralists Come Out of the Closet”, Global Investor, March 2003 (160), 8-11 (2003)).

As the complexity of portfolio management has increased, it is no longer possible to analyse or research at the level of individual securities and, as a result, stocks have been grouped into classes. One such classification system, based on “style”, was to group the stocks based on whether a stock is undervalued, and if not, whether the growth prospects are high. There were several reasons for the style-based classification such as: style as a classification method, style as a way to measure money managers' performance, and using style to gain fine-grained control over a portfolio.

Pursuant to style as a classification method, one of the mechanisms of human thought is classification whereby objects are grouped into categories based on some similarity among them. In financial markets, this has resulted in the creation of groups within a portfolio to which the investor allocates one or more stocks. From this evolved “style investing”, a process of allocating funds among styles rather than among individual securities. (Barberis, N. and Thaler, R., “A Survey of Behavioral Finance”, Working paper, http://ssrn.com/abstract=327880, accessed on 19 Mar. 2005 (2001)). The focus is on the asset class rather than the asset itself.

In using style as a way to measure performance of money managers, by creating categories of assets, investors can evaluate the performance of professional money managers since a style automatically creates a peer group of managers who pursue that particular style. (Barberis, N. and Thaler, R., “A Survey of Behavioral Finance”, Working paper, http://ssrn.com/abstract=327880, accessed on 19 Mar. 2005 (2001)). This has also resulted in the birth of style-based indexes such as S&P Barra Growth and S&P Barra Value indexes offered by Barra, Inc., 2100 Milvia Street, Berkeley, Calif. 94704 U.S.A. so that the performance of the asset classes can be benchmarked.

Style is also used to achieve fine-grained control over a portfolio. While fine-tuning at the high portfolio level cannot be achieved, fine-tuning at the individual security level is too detailed and impractical. Styles provide an intermediate level, which gives better control to the money managers and allows investors to process vast amounts of information reasonably efficiently. (Mullainathan, S. and Thaler, R., “Behavioral Economics”, Yale School of Management's Economics Research Network, Working papers, 1-13 (2000)).

Value and growth are now widely recognized distinct specializations adopted by money managers. (Chan, L. K. C. and Lakonishok, J., “Value and Growth Investing: Review and Update”, Financial Analysts Journal, 60(1), 71-87 (2004)). A growth investment strategy is sometimes defined as holding securities of companies with substantial growth prospects, thereby providing high returns to investors over the long run. The value investment strategy involves selecting companies whose securities can be purchased for prices that are below their estimated “underlying values.” (Capaul, C., Rowley, I. and Sharpe, W. F., “International Value and Growth Stock Returns”, Financial Analysts Journal, 49(1), 27-37 (1993)). To implement this strategy, some investigators have adopted a classificatory scheme based on one classificatory measure—the current price per share divided by the most recently reported book value per share. While the market price represents investors' assessments of future prospects, again based on the assumption of efficient market hypothesis, the book value represents the past costs of a company. The greater the ratio, the greater the future prospects which would fall into the growth territory. (Carlo et al. 1993). A price-to-book ratio of less than one means the company is trading at a discount to book value, representing a bargain. (Freedman, J., “The Tools You'll Use”, Money, 33(10), 118-119 (2004)).

Bourguignon and De Jong say that the style of investors can be recognized by looking at the stocks they select and how their portfolios fare. (Bourguignon, F. and De Jong, M., “Value versus Growth”, Journal of Portfolio Management, 29(4), 71-79 (2003)). Bourguignon and De Jong differentiate the two investors based on what they look out for: value investors tend to make short-term bets as they play on price movements, while growth investors bet more on structural changes in the company. But this is contradicted by studies, such as that of Fama and French, who have demonstrated that value stocks outperformed growth stocks in the markets around the world using historical portfolio returns between 1975 and 1995. (Fama, E. F. and French, K., “The Cross-Section of Expected Stock Returns”, Journal of Finance, 47(2), 427-467 (1992)). The fact that value stocks earn higher returns compared to growth stocks even in the longer term has given birth to the so-called “value premium” puzzle in asset pricing. This has continued to be an ongoing debate between those who advocate rational asset pricing and proponents of behavioural finance. (Doukas, J. A, Francis, K. and Pantzalis, C., “Divergent Opinions and the Performance of Value Stocks”, Financial Analysts Journal, 60(6), 55-65 (2004)).

Others believe that these are not two different or opposing styles but just two different scales. (Brent, A., “Gridlock: Are Style Boxes Out of Style?” Mutual Fund Market News, 9(47), n. pag (2001)). This gave rise to the “Growth at Reasonable Price” (GARP) strategy, a blend of the above two styles wherein a growth stock is purchased at a value. (Harvey, R., “The World (of Investing) According to GARP”, CPA Journal, 68(9), 19 (1998)). This strategy looks for companies that are somewhat undervalued and have solid sustainable growth potential. Warren Buffet doubts this classification system and says that the investment professionals are wrong when they say one has to choose between the two approaches as if the mixing of the two terms is seen as “intellectual cross-dressing.” According to Buffet, “the two approaches are joined at the hip.” (Hagstrom, R. G., The Warren Buffet Portfolio: Focus Investment Strategies of the World's Greatest Investor, Chichester, UK: John Wiley & Son Ltd. (1999)).

A model, while being a simplification of reality, cannot be simplified to such an extent that it ends up being too far from reality. While the introduction of classification simplified information processing and comparison, it also introduced a whole host of problems, starting from its definition to its misrepresentation. Numerous studies later, a consensus has not developed on the definition of value and growth stocks. The problem with this approach was that any classification has to be based on distinct attributes (i.e., the constituents of the class should have attributes that can be distinctly identified from others). If these attributes are not clear, there is ambiguity on the very classification system. In spite of the ambiguity of style investing, style classification cannot be avoided because of the reliance of the investment world on this classification in spite of its ambiguous and inconsistent definitions and usage. Ibbotson introduced this point of view by suggesting that the answer to the debate is that both sides may be right and that the difference between value and growth stocks is the combination of their different risks as well as mistakes in the marketplace. (Ibbotson, R. G., “Global Asset Allocation: Philosophy, Process, and Performance”, Journal of Investing, 9(1), 39-52 (2000)).

But how does this relate to the information asymmetry problem between the investor and the company? Information asymmetry is an outcome of the way markets evolved due to the above theories and the tools introduced by them. The over-reliance on the share price was a direct outcome of efficient market hypothesis, which gave the idea that the share price fully reflects all the available information. Starting with this assumption, the industry developed many indicators based on ratios such as price-to-equity ratio that rely on the share price. These indicators can be true only if efficient market hypothesis holds good for the company concerned. The capital asset pricing model gave a notion that beta can be a proxy for risk and that a few statistical numbers can quickly unearth what fundamental analysis took ages to do. While the simplicity of these beliefs quickly grabbed the attention of the investment community, the various caveats that accompanied it were conveniently ignored, thereby resulting in a one-sided view. While behavioural finance is catching up gradually, critics point out that it has turned into a “catch all” container for all those scenarios that cannot be explained by the traditional theories. Moreover, behavioural finance does not provide ready to use formulae that the industry is so used to.

Style based classification, though originally introduced to simplify grouping, has in many instances either been turned into a straitjacket to build a portfolio or a veil for institutional investors to hide behind, to misrepresent the performance to their clients, and to dislodge their peers. There were two major outcomes of style classification. First, the security of a company was associated with a certain style tag. Second, the investor was associated with a certain investment style or a certain combination of styles. Studies on the fund classification system have shown surprising results, wherein many funds in reality lay outside their original categories. The misclassifications of mutual funds were not random events and were based on empirical results: about 40% of the funds examined displayed return patterns that more closely resembled another category than that listed in their prospectuses. (DiBartolomeo, D. and Witkowski, E., “Mutual Fund Misclassification: Evidence Based on Style Analysis”, Financial Analysts Journal, 53(5), 32-44 (1997)).

As if the challenge of identifying a value-growth position of a company is not sufficient, the use of names by mutual funds and investment management companies to describe their funds have little or no correlation with the kind of stocks they hold in their portfolio. The U.S. Securities and Exchange Commission (SEC) adopted the misleading names rule (www.sec.gov) to prevent such misleading names so as to protect the interest of the shareholders. (Valenti, C., “SEC Adopts Rule Aimed at Curbing Misleading Fund Names”, http://www.thestreet.com/funds/funds/1261190.html [online], accessed on 19 Mar. 2005 (2001)). A misclassification can mean the shareholders of these mutual funds are assuming financial risks greater than what they were led to believe. Even after the introduction of the misleading names rule, names cannot be taken at their face value. (Bullard, M. “Despite SEC Efforts, Accuracy in Fund Names Still Elusive”, http://www.thestreet.com/funds/mercerbullard/1282823.html [online], accessed 19 Mar. 2005 (2005)).

This makes it all the more important for investor relations function of a company to look underneath the bonnet. This isn't without hurdles. The SEC requires the mutual funds and investment companies to disclose their portfolio holdings only on a quarterly basis, thus causing gaps in the information. While attempts are being made to bring in greater transparency by way of SEC imposing stricter rules in portfolio disclosures (see, e.g., www.funddemocracy.com), it is far from being implemented. Even if stricter rules in portfolio disclosures are implemented, this will not solve the problem completely as non-U.S. investors are not under any obligation to disclose such information. (Investor Relations Business, “IROs Want Timely Ownership Data”, Investor Relations Business, 8(19), 11 (2003)).

All this means that the evolution of the capital markets has been based on a number of assumptions and anomalies, which has made it difficult for investors and companies alike to communicate information to each other without it passing through these filters. When large investors use such tools as windows to look at individual companies for their buy-hold-sell decisions, it is highly likely that they will miss out on winners and bet on the losers.

What would thus be advantageous would be to provide a more realistic view in understanding the behaviour of an investor and arriving at a scale of potential investment, which is based on the investor's preference. This would enable companies in getting more value for the time and money spent by the investor relations function of a company by identifying and focusing on those investors who matter most. It would still further be advantageous to provide a benchmark index of institutional investors that can be readily used by any company that has its stock listed in a recognised stock exchange.

### SUMMARY OF THE INVENTION

A method of profiling investors in accordance with the principles of the present invention provides a more realistic view in understanding behaviour of investors and arriving at a potential investment value. A method of profiling investors in accordance with the principles of the present invention assists companies in getting more value for the time and money spent by identifying and focusing on those investors who matter most. A method of profiling investors in accordance with the principles of the present invention can provide any listed company with a benchmark index of institutional investors. A method of profiling investors in accordance with the principles of the present invention takes into account the current practices and definitions in the investment domain. A method of profiling investors in accordance with the principles of the present invention helps the company to track and compare its investors' behaviour over time. A method of profiling investors in accordance with the principles of the present invention helps the company understand the style, sector, geography and the size bias of an investor.

A method of profiling investors in accordance with the principles of the present invention assists a company in quantifying the style of both current and potential investors so that its investors can be ranked and compared. A method of profiling investors in accordance with the principles of the present invention enables a company to identify the style, sector, geography and the size bias of an investor. A method of profiling investors in accordance with the principles of the present invention enables a company to arriving at a dollar value to get a sense of the size and scale of an investor in the company's sector. A method of profiling investors in accordance with the principles of the present invention provides an improved understanding and quantification of the behaviour of institutional investors and provides a company with a tool to identify, attract, and retain current and potential investors. On a wider scale, a company listed on a recognised stock exchange can use the present invention as a tool to rank and profile behaviour of its investors and to identify any significant changes in their investment styles.

A method of profiling investors in accordance with the principles of the present invention adopts a behavioural approach and quantifies each investor's behaviour using a pseudo portfolio. The pseudo portfolio is created to see how an investor has behaved given a choice between a value and a growth stock. The investor's historical portfolio is filtered through the pseudo portfolio and the aggregate on the style and sector dimensions are sliced. This helps determine the value-growth preference of the investor and can be quantified as well in percentage terms.

### BRIEF DESCRIPTION OF THE DRAWINGS

FIG. 1 is a graph showing a comparison of Unilever NV and Unilever Plc share price movement.

FIG. 2 is a graph showing the frequency distribution of R² for U.S. Unilever investors.

FIG. 3 is a graph showing the frequency distribution of R² for U.S. Unilever Investors based on the S&P 500® index.

FIG. 4 is a graph showing the frequency distribution of R² for U.S. Unilever Investors on the S&P Barra Growth index

FIG. 5 is a graph showing the frequency distribution of R² for U.S. Unilever Investors on the S&P Barra Value index.

FIG. 6 is a graph showing the top 25 U.S. investors' asset holdings as a percentage of Unilever market capitalization.

FIG. 7 is a graph showing some key U.S. investors' historical group assets holdings.

FIG. 8 is a graph showing the Unilever Group assets held by some of the top investors.

FIG. 9 is a graph showing an example style value-growth drift of Capital Guardian Trust Company in consumer surplus sector.

FIG. 10 is a graph showing an example style value-growth drift of Capital Research Management Company in consumer surplus sector.

FIG. 11 is a graph showing an example style drift of Capital Guardian Trust Company in for all sectors.

FIG. 12 is a graph showing an example style drift of Capital Guardian Trust Company in the industrials sector.

FIG. 13 is a graph showing an example style drift of Capital Guardian Trust Company in the consumer staples sector.

FIG. 14 is a graph showing an example style drift of Capital Guardian Trust Company in the information technology sector.

FIG. 15 is a graph showing an example style drift of Capital Guardian Trust Company in the health care sector.

FIG. 16 is a graph showing the style drifts of some key U.S. Investors in the consumer staples sector.

### DETAILED DESCRIPTION OF THE PREFERRED EMBODIMENTS

Most investment theories and models focus on providing tools and techniques to the investors in identifying the right company to add to their portfolios. Very little focus has been placed on helping companies understand the behaviour of investors and making companies more attractive to current and potential investors. Due to limited resources and time, prioritising the investors and seizing the attention of key investors who have significant potential for investing in the stock of a company is a challenge for any investor relations efforts of a company.

For an investor in today's investment world, obtaining quality information at the right time can make all the difference between winning and losing. For a company, disseminating information to the right investor at the right time can make all the difference between being picked and getting dumped. This task is more difficult to achieve that it appears.

Institutional investors now account for over 50% of all publicly traded holdings in the U.S. (Bathala, C. T., Ma, C. K. and Rao, R. P., “What Stocks Appeal to Institutional Investors?” Journal of Investing, 14(1), 14-24 (2005)). The investor relations efforts of a company, the front-end of a listed company to its investor community, communicates the policies and messages of the company to its current and potential investors. Institutional investors are generally viewed as more sophisticated, allowing managers to reduce information asymmetries between themselves and these owners of the company. A potential benefit of reduced information asymmetry is the improved liquidity of the securities of the company, which in turn lowers the cost of capital. (Downs, D. H., “The Value in Targeting Institutional Investors: Evidence from the Five-or-Fewer Rule Change”, Real Estate Economics, 26(4), 613-650 (1998)). Institutional investors are singled out in many studies for having a negative influence on the ways companies are financed, with their preferences for investing only in large stocks and having short-term investment horizons. Nevertheless, institutional investors improve the efficiency of corporate governance, hold greater power than individual investors in influencing companies, and improve the information efficiency of financial markets to some extent. (Menkhoff, L., “Institutional Investors: The External Costs of a Successful Innovation”, Journal of Economic, 36(4), 907-934 (2002); Tricker, B., “The Role of the Institutional Investor in Corporate Governance”, Corporate Governance. 6(4), 213-217 (1998)).

With the increasing regulatory requirements such as the U.S. Sarbanes-Oxley Act of 2002, companies are forced to become ever more transparent to investors and the general public on the inner workings of the company. This means investors are now playing a bigger role in deciding the outcome of a company's internal strategies. Company managers now want to know how the market will react to their new strategies and major decisions, as investors who fail to understand the motives of a company might punish the stock. Studies by the consulting firm McKinsey & Company, 55 East 52nd Street, 21^{st} Floor, New York, N.Y. 10022 U.S.A. have shown this to be on the top of Chief Executive officer's concerns (www.mckinseyquarterly.com).

Today's investors in general and institutional investors in particular have a wide range of stocks from which to choose. This means investors cannot afford the time or patience to look into the fundamentals of every company in detail. Scarcity of investor time is an under-valued dynamic in the investment process. (Wagner, B., “Ramping Up Communications to the Buy Side”, Financial Executive, 21(1), 42-44 (2005)). There is significant evidence of the relationship between information disclosure by companies, share price volatility, and the cost of capital. (James, C., “In my opinion”, European Business Forum, 18, 54-56 (2004)). No one is in a better position to know about a company than the company managers. The information required by investors overlap considerably with the information required by managers to operate the company. While the marginal cost in gathering and processing the data needed by investors might be minimal, the cost of transmitting this information to investors so that they can use it efficiently is considerable. This has resulted in extensive literature on the principal-agent problem and signalling models. (Merton, R. C. (1987), “A Simple Model of Capital Market Equilibrium with Incomplete Information”, Journal of Finance, 42(3), 483-510 (1987); Dwight, L., “The Market for Control”, Corporate Board, 11(60), pag (1990)).

Even if an effective disclosure leads to increased cost, these costs should be weighed against lower cost of capital and lower share price volatility. Craven and Marston suggested that once management realized the strategic importance of investor relations in attracting and retaining institutional investors in their company, they will gladly incur the costs of executing such a programme. (Craven B. M. and Marston, C. L., “Investor Relations and Corporate Governance in Large UK Companies”, Corporate Governance, 5(3), 137-142 (1997)). The perception the investors have of the company plays an important role in influencing the share price of a company—in addition to its financial performance—and institutional investors are quick to punish on any perception of mismanagement and irregularity. (Investor Digest, “Putting the PR into the IR”, Investor Digest, November 2002, pag (2002)). Wright and David demonstrate the ripple effect the information asymmetry has on the company, the cost of capital for the company, and the relationship this has on share price and the subsequent feedback of the share price on the cost of capital. (Wright, P. and Phillips, D., “Communicating with the Marketplace”, European Business Forum, 18, 52-59 (2004)). Information deficiency in a market environment is one of the sources of inefficient pricing causing the securities, at least for a while, to be under-priced or overpriced. (Arbel, A., Carvell, S. and Strebel, P., “Giraffes, Institutions and Neglected Firms”, Financial Analysts Journal, 39(3), 57-64 (1983)). Fama refers to the judgement bias of investors who react differently to the same scenario of price movement: one bias wherein the investor perceives earnings as a correction and under-reacts; and another bias wherein the investor perceives the same earnings as trending and, as a result, extrapolates the trend causing the stock-price to over-react. (Fama, E. F., “Market Efficience, Long-term Returns, and Behavioral Finance”, Journal of Financial Economics, 49, 283-306 (1997)). In the short term, trading based on market models and indexes have added more noise to the information in the public domain, often uncoupling the share price from the underlying economic realities of the company. (Sloan, A., “The Shoes Keep on Dropping”, Newsweek, 132(11), 50-52 (1998)).

Informed investors tend to give more importance to private information than to the information in the public domain. This is one of the reasons for what is referred to as the over-reaction phase, causing abnormal stock price performance. (Daniel, K. D., Hirshleifer D. A. and Subrahmanyam, A. (1997), “A Theory of Overconfidence, Self-Attribution, and Security Market Under- and Over-reactions”, http://ssrn.com/abstract=2017, accessed on 8 Mar. 2005 (1997)). This is later followed by the correction phase caused by the flow of public information if it is any different from the investor's private information. It is thus evident that the quality of the information the company pushes into the public domain can prevent adverse movements of its stock price and can also determine how quickly such movements can be corrected. This is more so if a specific group of investors is targeted and the message is packaged accordingly. (McMullen, M., “IR: Staying on Top in the '90s”, Public Relations Journal, April 1990, 30-31).

Knowing the styles of investors and their potential investment in a sector enables companies to decide which investor to target and which investor to ignore. Since the institutional investors hold value and growth stocks in their portfolios, the knowledge of a good estimate for their value-growth ratio will allow the company to evaluate whether it is worth committing time and resource to attract the investor. To do this, two components are needed; the investor's value-growth style and the sector weights for both the styles. This also provides the company with a basis to prioritise among several investors, especially during road shows where time and resources are limited.

The above discussion on efficient market hypothesis showed the reliance placed by the industry on share price as a true indicator of the company's fundamental value. The industry developed tools and methods based mainly on the share price, even while acknowledging that the share price is not an accurate indicator of the fundamental value of a company. Styles were defined using formulas such as price to earnings ratio, price to book ratio, etc., that relied heavily on share price. If the share price was a good indicator base on which investors based their decisions, there should be a strong relationship between the movement of share price and the changes in the asset held by the investors. In other words, share price has a significant explanatory power in understanding the changes to group asset held by an investor.

A method of profiling investors in accordance with the principles of the present invention looks at the problem from the other side of the window by taking the perspective of the company. Just as investors look for good stocks to add to their portfolio and sell what in their opinion are “not-so-good” stocks, companies have to pitch their message to the investors, both present and potential, by filling the gaps in the information available to investors so that they not only retain the stock of the company, but also buy more stocks. This would help reduce noise and artificial volatility in share prices, which otherwise would add more strain to the limited resources of the company.

A method of profiling investors in accordance with the principles of the present invention accepts the premise that style investing exists, though defined and practised inconsistently. A method of profiling of the present invention provides an improved understanding and quantification of the behaviour of institutional investors and provides companies with a tool to identify, attract, and retain current and potential investors. On a wider scale, any company listed on a recognised stock exchange can use a method of profiling of the present invention as a tool to rank and profile behaviour of its investors and to identify any significant changes in their investment styles.

A method of profiling investors in accordance with the principles of the present invention focuses on the impact of style investing on information asymmetry between a company and its key investors. A method of profiling investors of the present invention adopts a behavioural approach and quantifies behaviour of investors. This iterative approach strikes a balance between focusing on key investors and profiling all investors, and offers some useful insight into the investment style of the investor.

One way of understanding the investor is to assess the other holdings in the portfolio of the investor. This provides valuable information and enables a company to see how an investment manager acts versus what it says its intensions are. (Wagner, B., “Ramping Up Communications to the Buy Side”, Financial Executive, 21(1), 42-44 (2005)). A method of profiling investors in accordance with the present invention formalises this observation and quantifies it to arrive at the investment potential of the investor. The “style” of an investment fund can be determined by analysing the historical returns of the fund with those of portfolios of different style stocks. A large part of the return of a fund can be attributed to the return on its style. (Capaul, C., Rowley, I. and Sharpe, W. F., “International Value and Growth Stock Returns”, Financial Analysts Journal, 49(1), 27-37 (1993)). A method of profiling investors in accordance with the present invention uses quantitative models not to substitute, but to support fundamental investment approach to make qualitative forecasts. (Herold, U., “Portfolio Construction with Qualitative Forecasts”, Journal of Portfolio Management, 30(1), 61-73 (2003)).

A method of profiling investors in accordance with the present invention formalises an assessment of the other holdings in the investor's portfolio and quantifies it to arrive at the investment potential of the investor. The “style” of an investment fund is determined by analysing the historical returns of the fund with those of portfolios of value stocks and growth stocks. A large part of the return of the fund can be attributed to the return on its style. A method of profiling of the present invention uses quantitative models not as a substitute for but to support fundamental investment approach to make qualitative forecasts.

In accordance with the principles of the present invention, a pseudo portfolio is created to see how an investor has behaved given a choice between a value stock and a growth stock. The historical portfolio of an investor is filtered through the pseudo portfolio and the aggregates are sliced on one or more dimensions such as for example style, sector, geography and/or size. This helps determine the value-growth preference of the investor, which can be quantified as well.

Initially, key investors are identified. The portfolio of stocks held by each of these key investors is collected. A benchmark pseudo portfolio is constructed. The benchmark pseudo portfolio is based on style and sector. This generates a dilemma to the investor in selecting between stocks in identical sectors. Each sector contains one or more companies that fit the style-sector criteria. The only difference between the stocks from which the investor has to choose is that one is identified as a certain style stock while the other is identified as a different style stock. With all other parameters being equal, the benchmark pseudo portfolio should expose bias of an investor towards a certain style. From the collected historical portfolio information, companies held in an investor's portfolio are compared to companies in the benchmark pseudo portfolio. Matches are recorded against the relevant investor and set aside for aggregation.

Next, the arithmetic mean of the aggregated dollar value invested by each investor in the benchmark portfolio is sliced based on the style dimension and the sector dimension. This is converted into a percentage of the benchmark pseudo portfolio's total market capitalisation. During this step, the average dollar value invested in stocks for each of the style-sector combination is computed. This amount is converted into a percentage of market capitalisation for the benchmark pseudo portfolio. In particular, the style percentage and the style component are calculated in accordance with:

% investment in the example benchmark portfolio in A Style =
(Average (Iₜ, I_{(t-1), I}₍ₜ₋₂₎...I₁))/B_{mc}) * 100
Style component = (Avg. investment in A Style Stocks/Avg. investment
in the example benchmark portfolio) * 100

where B_{mc} is the total market capitalisation of all the stocks included in the benchmark pseudo portfolio; and Iₜ, I₍ₜ₋₁₎, I₍ₜ₋₂₎ . . . I₁ are the dollar value of the investments investor I has invested in the benchmark pseudo portfolio in each quarter in stocks of a certain style starting from now (t) to the first available quarter.

The following is an example presented for the purposes of explanation and not to narrow the scope of the present invention. As known in the art, a method of profiling investors in accordance with the principles of the present invention can be preferably embodied as a system cooperating with computer hardware components, and as a computer-implemented method.

### EXAMPLE

While the following discussion utilizes the Unilever Group as an example company, it is to be understood that the principles of the present invention can be applied to any company that has its stock listed on a recognised stock exchange. The Unilever Group, Unilever House, Blackfriars EC4P 4BQ Great Britain is an Anglo-Dutch fast moving consumer goods company that is made up of Unilever NV, registered in the Netherlands, and Unilever Plc, registered in United Kingdom. Unilever's investor relations is grouped into several geographic regions such as North America, Europe, UK and Ireland, and Asia.

The following discussion is confined to investors based in United States for several reasons. The reporting in different geographies differs substantially depending on the local disclosure regulations and requirements. With the mandatory filing requirement under Section 13(f) of the U.S. Securities Exchange Act of 1934, 15 U.S.C. §78m(f), the quality of information available for the U.S. markets is superior compared to other developed markets. In addition, two readily available variants of the S&P 500® index, the S&P Barra Growth and the S&P Barra Value, split the well-known S&P 500® constituents into growth and value companies, thus providing a benchmark index that not only represents the market, but also has a generally acceptable style definition. This list is revised every six months. To implement the principles of the present invention in other geographies, the quality of information available should be acceptable and a benchmark index that not only represents the market, but also has a generally acceptable style definition should be present; if the market index does not provide such a value-growth split of its constituents, a market index will need to be created by, for example, using a methodology similar to the one defined by S&P and Barra.

Unilever NV and Unilever Plc, the two entities that together form the Unilever Group, are connected based on a number of complex cross holdings. Unilever NV is listed in the New York Stock Exchange, 11 Wall Street, New York, N.Y. 10005 U.S.A. (“NYSE”) under the ticker UN; Unilever Plc shares are listed as American Depository Receipts (ADR) under the ticker UL. The shares of Unilever NV and the shares of Unilever Plc trade at different prices. This provides two indicators from which to choose. If these stocks have different price movements, then both stock prices have to be factored because an investor can hold a combination of Unilever Plc and Unilever NV shares; however, if they exhibit similar movements, one can be substituted as a proxy for another.

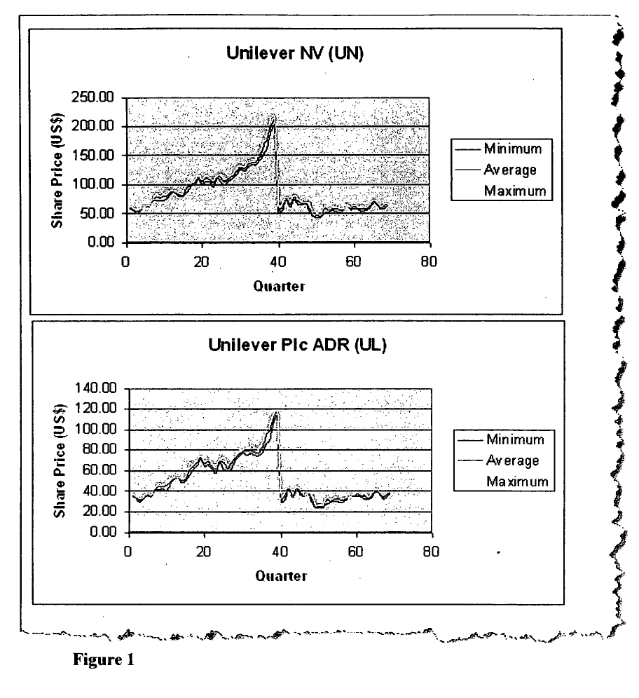

Initially, the historical share price information from Yahoo Finance, Yahoo! Inc., 701 First Avenue, Sunnyvale, Calif. 94089 U.S.A. (available at finance.yahoo.com) for Unilever NV stock and Unilever Plc ADRs is used to determine if these stocks had different price movements. FIG. 1 is a comparison of Unilever NV and Unilever Plc share price movement, showing the minimum, average, and maximum Unilever NV and Unilever Plc share prices for each quarter between January 1988 and January 2005, a total of 68 quarters. Visually, the two share prices demonstrate similar patterns in their movement while trading at different prices.

The correlation coefficient measures the degree of linear relation between the returns of the two stocks. A correlation coefficient that is closer to +1 indicates that the returns on the two assets are linearly related with a positive slope. (Benninga, S., Numerical Techniques in Finance, Cambridge, UK: The MIT Press (1989)). A correlation that is +1 represents a perfect positive correlation. If the return distributions are independent, then the correlation coefficient will be zero. Table 1 shows the correlation coefficient of the monthly returns of Unilever NV and Unilever Plc share price as 0.9896 for the past 17 years, indicating a high degree of linear relation.

TABLE 1
Correlation coefficient of Unilever NV and PLC share price

| | Unilever NV (UN) | Unilever PLC (UL) |
|---|---|---|
| Unilever NV (UN) | 1 | |
| Unilever PLC (UL) | 0.989630023 | 1 |

Table 2 shows results of a first-order linear model, also called the Simple Linear Regression model and the coefficient of determination, R², as 0.9793. This means Unilever NV is a significant explanatory variable that explains 97.9% of the variation in share price of Unilever Plc. The P-value in this relationship is 9.804E-175. The lower the P-value, the more reliable of an indicator the observed relation between variables in the sample is of the relation between the respective variables in the population. (Koop, G., Analysis of Economic Data, 2^{nd} ed., Chichester, UK: John Wiley & Sons Ltd. (2005); Keller, G., Statistics for Management and Economics, 4^{th} ed., London UK: Belmont (1997)). The coefficient for Unilever NV, 0.5773, falls between the lower and upper confidence intervals of 0.5657 and 0.5888 at 95% confidence level. From this, Unilever NV share price can be used as a proxy for Unilever Plc shares.

TABLE 2a
Regression of Unilever Plc share price on Unilever NV share price
Regression Statistics

| | |
|---|---|
| Multiple R | 0.989630023 |
| R² | 0.979367582 |
| Adjusted R2 | 0.979266936 |
| Standard Error | 3.081219915 |
| Observations | 207 |

| | | Standard | | | | |
|---|---|---|---|---|---|---|
| | Coefficients | Error | t Stat | P-value | Lower 95% | Upper 95% |
| Intercept | 0.941063294 | 0.551261055 | 1.70711 | 0.08931568 | −0.145804444 | 2.027931032 |
| | | | 98.6449 | | | |
| UN | 0.577335414 | 0.005852662 | 2 | 9.804E-175 | 0.56579629 | 0.588874538 |

Assuming all other things as being equal, if the share price increase, the price-equity ratio will increase making it less attractive to the value investors and possibly appeal to growth investors. On the other hand, if the share price falls, this might attract value investors and can cause the growth investors to rebalance their portfolio. If this holds true for Unilever's U.S. investors, this would provide a quick screening method to identify investors based on their value/growth style.

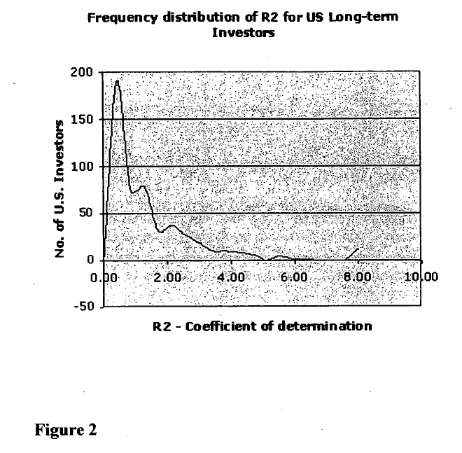

The raw data of Unilever Group assets held by U.S. institutional investors was collected for each quarter for the period from August 1999 to January 2005 from DataStream, 50 Datastream Plaza, Greenville, S.C. 29605 U.S.A. for 747 investors. Of these, 513 investors had held Unilever stocks for at least 24 months. To profile long-term investors, only the 513 long-term investors were considered in the analysis. Table 3 lists the frequency distribution of R² for U.S. Investors while FIG. 2 shows a graph of frequency distribution of R² for U.S. Investors.

TABLE 3
Frequency distribution of R² for U.S. Investors

| R² | Frequency |
|---|---|
| 0.00-0.41 | 1 |
| 0.42-0.84 | 190 |
| 0.85-1.26 | 74 |
| 1.27-1.69 | 79 |
| 1.70-2.11 | 32 |
| 2.12-2.54 | 37 |
| 2.55-2.96 | 27 |
| 2.97-3.39 | 19 |
| 3.40-3.81 | 10 |
| 3.82-4.23 | 10 |
| 4.24-4.66 | 8 |
| 4.67-5.08 | 6 |
| 5.09-5.51 | 0 |
| 5.52-5.93 | 4 |
| 5.94-6.36 | 1 |
| 6.37-6.78 | 1 |
| 6.79-7.21 | 0 |
| 7.22-7.63 | 0 |
| 7.64-8.05 | 1 |
| 8.06-8.48 | 13 |
| Total | 513 |

The Simple Linear Regression of each of the 513 Investors' group asset holdings on Unilever NV share price returned a maximum R² of 8.48%, which indicates that at the most, only 8.48% of the variation in the Investor's holdings in Unilever stock is explained by Unilever's share price. The frequency distribution of the R² for all the 513 investors show only 13 of these investors fall into the 8.06%-8.48% range. The frequency distribution shows a decrease in the number of investors that fall in a given R² range as the R² increases on the x-axis.

This analysis fails to establish a significant relationship between the group asset held by an investor and Unilever NV share price. Next, whether such a relationship exists between the group holdings and a market index is explored. The single-index model is an attempt to simplify some of the computational complexities by making an assumption that the returns of each asset can be linearly regressed on a market index, which is a proxy for the market portfolio. (Benninga, S., Numerical Techniques in Finance, Cambridge, UK: The MIT Press (1989)). This suggests that the market index return has significant explanatory power in determining the company stock returns. Studies have indicated that perhaps half of the fluctuations in the price of individual common stocks may be accounted for by fluctuations in the market as a whole. (Block, F. E., “Elements of Portfolio Construction”, Financial Analysts Journal, 25(3), 123-129 (1969)). If this were true, using a market index would not only account for specific risk and returns of the company, but also the industry effects on such movements. This can in turn exhibit a certain level of relatedness with the investor holding. This would also exhibit a higher correlation if the investor were not a stock picker and uses index investing as one of the main strategies. This example analysis uses S&P 500® index, the S&P Barra Growth, and the S&P Barra Value index returns to see if a strong relationship is exhibited between the investors' Unilever Group asset holdings and the three indices.

The monthly returns for the S&P 500® index, S&P Barra Growth index, and S&P Barra Value index were collected for the period between August 2001 and January 2005 (www.barra.com). Unilever stocks were considered as value stocks during this period. The results of the simple linear regression of Unilever Group assets for each U.S. investor run individually on monthly returns of S&P 500® index, S&P Barra Growth index, and S&P Barra Value index separately are set forth in Table 4.

TABLE 4
Regression results of Investors' holdings on various indices

| Index | Minimum % | Average % | Maximum % |
|---|---|---|---|
| S&P 500 ® | 0.000198351 | 5.365273348 | 46.08497149 |
| S&P Barra Growth | 0.000279133 | 5.142940872 | 50.81778121 |
| S&P Barra Value | 9.98E−05 | 5.247182703 | 40.50988184 |

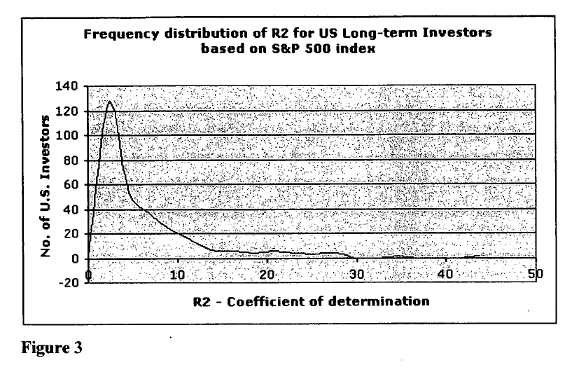

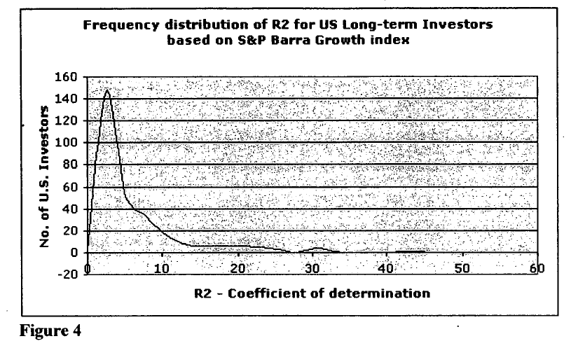

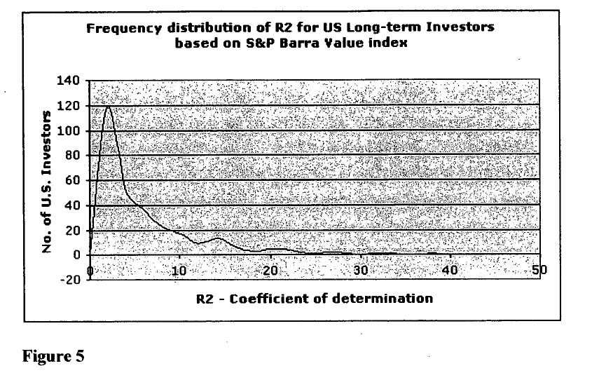

From Table 4, it is clear that the explanatory power for all the three indices is around 50% at the most while the average is around 5%. The frequency distributions of R² for the U.S. Investors for the three indexes are set forth in FIGS. 3, 4, and 5, where FIG. 3 shows the frequency distribution of R² for U.S. Investors based on the S&P 500® index, FIG. 4 shows the frequency distribution of R² for U.S. Investors on S&P Barra Growth index, and FIG. 5 shows the frequency distribution of R² for U.S. Investors on the S&P Barra Value index.

The frequency distribution in FIGS. 3, 4, and 5 show that as the R² increases in the x-axis, the number of U.S. investors whose holdings in Unilever Group assets can be explained based on the index returns decreases for all the three indices. This goes on to show that any method of profiling the investors based on such indicators will not produce useful results. Moreover, even in those cases where the R² was 50%, these can be cases of spurious relationship as the number of investors who seem to exhibit this level of R² is very small. As Opiela observed, the risk and return models that are very popular among extrapolators might work well during stable times, but soon these tools will shake these extrapolators out of their complacency. (Opieala, N., “Adjusting the Course of Portfolio Design”, Journal of Financial Planning, 17(6), 66-71 (2004)). This is because of the inherent flaws in these models, which expect the world to work in a certain way.

Thus, the results from trying to find out the investment behaviour of investors based on Unilever NV share price, S&P 500® index, S&P Barra Growth index, and S&P Barra Value index produced a low R² upon which not much credibility can be placed. This demonstrates that, when it comes to understanding the behaviour of investor, there is no substitute to analysing the investor individually; however, companies are constrained by time and resources. The cost of understanding all the investors for any company may exceed any benefits gained by the process. The McKinsey study (www.mckinseyquarterly.com) states that it is generally the top 30 investors of a company who actually influence the movement of a company's stock price. By focusing on these key investors, an appropriate trade-off of completeness for usefulness and timeliness can be brokered.

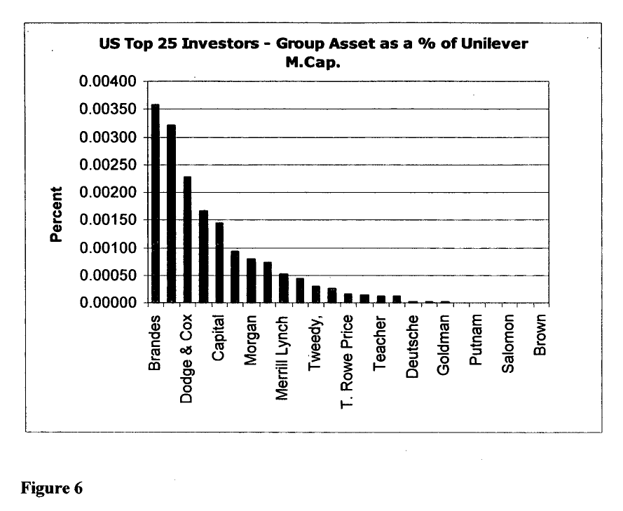

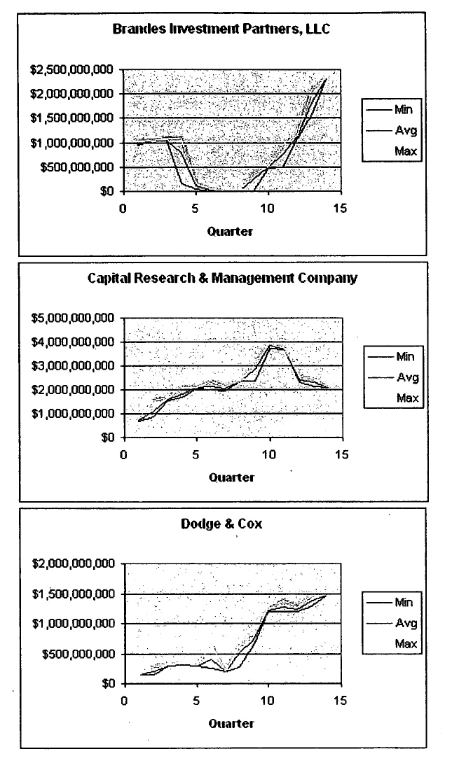

FIG. 6 shows the top 25 U.S. investors' group asset holdings as a percentage of Unilever market capitalization. Thus, focus is placed on ten key investors based in United States who have held Unilever stocks for more than 24 months. Studies from McKinsey have shown that six to eight quarters is a period long enough to define an investor as long-term and short enough to observe significant movements and avoid noise (www.mckinseyquarterly.com). Table 5 summarises the characteristics of these key investors:

TABLE 5
Key U.S. Investors of Unilever Group

| | Equity | Average | Average |
|---|---|---|---|
| | Under | number | investment in |
| | Management | of stocks | Unilever Group |
| | (US$ in | in | Asset (US$ in |
| Investor Name | billions) | portfolio | millions) |
| American Century Investment Mgmt. NY | 7.625 | 1737 | 1.22 |
| Brandes Investment Partners, LLC | 38.894 | 193 | 2,322.58 |
| Capital Guardian Trust Company | 53.597 | 809 | 927.85 |
| Capital Research & Management Co | 361.318 | 824 | 2,072.72 |
| Dodge & Cox | 73.404 | 224 | 1,471.08 |
| Lazard Asset Management (US) | 24.257 | 961 | 597.11 |
| OppenheimerFunds, Inc. | 61.499 | 2108 | 10.36 |
| Teacher Retirement System of Texas | 56.876 | 2678 | 78.09 |
| Tweedy, Browne Company, L.L.C. | 3.040 | 123 | 196.03 |
| Wellington Management Company, LLP | 227.983 | 5465 | 1.95 |

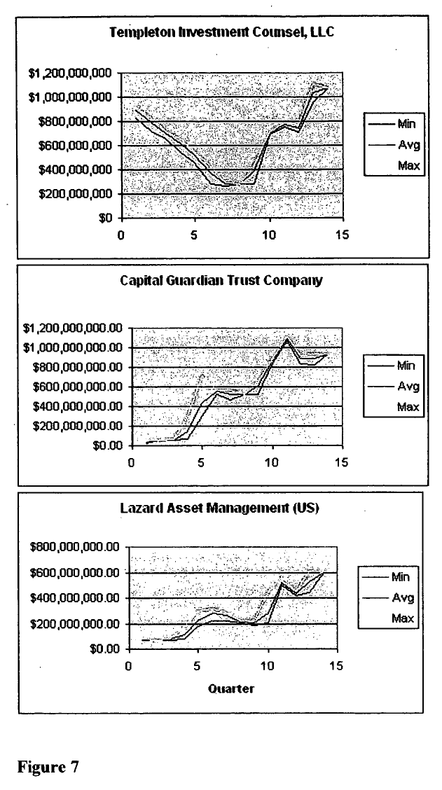

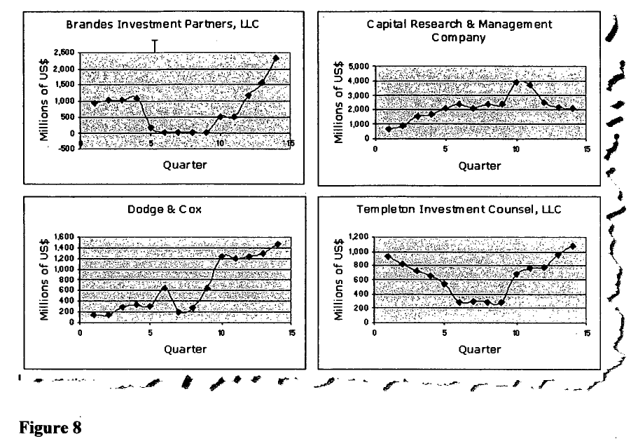

FIG. 7 shows key U.S. investors' historical group assets holdings. FIG. 8 shows the Unilever Group assets (millions of U.S. dollars) held by some of the key investors during the last 15 quarters. A quick look at the trend shows different signatures for each investor, which again justifies the individualized approach to understanding the investors instead of the “one-size-fits-all” approach.

Next, the historical portfolio holdings of all the investors being profiled was collected. The complete portfolio of common stocks held by each of these investors at the end of each quarter for the period ranging from February 1999 to January 2005 was collected. The information was obtained from the SEC website (www.sec.gov.com). This included the following data items: Date (of the quarter)—the institutional managers who are managing over $100 million must disclose their holdings on a quarterly basis in accordance to Section 13(f) of the Securities and Exchange Act of 1934 (www.investopedia.com); the CUSIP number—the company name or the name of the issuer of a certain stock cannot be relied upon to uniquely identify a company either due to mechanical or human errors or due to the change in the name of the company over time (the CUSIP number (Committee on Uniform Securities Identification Procedures) was introduced in 1967 to uniquely identify issuers) (www.sec.gov); the name of the issuer—the name of the company that issued the stock; the value of each stock—published in thousands of U.S. dollars; and the number of shares held. A total of 270,445 company records were collected for the ten investors' portfolio from the historical portfolio information.

In accordance with the principles of the preset invention, a benchmark pseudo portfolio was constructed. Portfolios can be constructed based on several parameters. When the parameters are based on market information, the portfolio constituents can be re-ranked at frequent intervals based on the performance of these constituents in the market. On the other hand, if the criteria are based on company-specific information, the ranking is possible only on an annual basis. The criteria also can be based on a combination of parameters. (Carhart, M. V., “Portfolio Construction in Emerging Markets”, Emerging Markets Quarterly, 4(3), 68-79 (1996)). While there is a wide array of parameters on which to base the portfolio, the parameters should be such that the portfolios do not need to be rebalanced too frequently as this would change the point of reference and could distort the results. (Wang, P., “Does Asset Allocation Really Matter?” Money, 31(9), 95-97 (2002)).

Part of the portfolio construction policy as suggested by Dijk et al. (2004) is used based on two dimensions: namely, style and sector. (Van Dijk, R. and Keijzer, T., “Region, Sector and Style Selection in Global Equity Markets”, Journal of Asset Management, 4(5), 293-308 (2004)). Due to the lack of continuity of information in non-U.S. geographies, the United States was analyzed; again, however, the present invention is well suited for multi-regional analysis. Care should be taken in selecting the sectors while constructing the benchmark portfolio as certain sectors appear to attract both growth and value managers, such as for example consumer durables and non-durables and producer manufacturing. (Investor Relations Business, “Sector Preferences of Growth vs. Value Investors”, Investor Relations Business, 4(3), 11 (1999)).

While the present invention does not have an upper limit on the number of sectors, the analysis used five sectors within each of the value-growth components. The five sectors selected have a good mix of value and growth stocks and are based on S&P's sector definition (www.standardandpoors.com). The sectors chosen for this analysis were: Consumer Discretionary (CD); Consumer Staples (CS); Health Care (HC); Industrials (IND); and Information Technology (IT).

The idea is to generate a dilemma to the investor in selecting between stocks in identical sectors. Each sector contains one or more companies that fit the style-sector criteria. The companies are picked from the constituents of S&P Barra Value Index and S&P Barra Growth Index. The only difference between the stocks from which the investor has to choose is that one is identified as a value stock while the other is identified as a growth stock. The total sector allocation will be in the range of US $90-110 billion. With all other parameters being equal (i.e. same geography and equal sector for both value and growth components), this type of portfolio should expose any bias of an investor towards a certain style.

The historical portfolio holdings of each investor were passed through the benchmark pseudo portfolio. From the historical portfolio information, every company held in every investor's portfolio for every quarter for the past 24 quarters were compared to every company in the benchmark pseudo portfolio. Matches were recorded against the relevant investor and set aside for aggregation. At the end of this process, the arithmetic mean of the aggregated dollar value invested by each investor in the benchmark pseudo portfolio was sliced based on the value-growth dimension and the sector dimension.

The average dollar value invested by the investor in stocks for each of the style-sector combination in the benchmark pseudo portfolio was calculated. This amount was converted into a percentage of market capitalisation for the benchmark pseudo portfolio. A cross product of both these dimensions resulted in 12 combinations with 10 percentages for each style-section.

The percentage of market capitalisation for the benchmark portfolio for the style-sector of value-Consumer Staples is the investor's sector weight in Unilever's sector (Unilever is currently a value stock). The percentage of the investor's sector weight was converted as a dollar value of the investor's equity under management. This gave a sense of the investor's size and scale and was used to rank the investors and arrive at conclusions. Tables 6 and 7 list the example benchmark portfolio constituents with their market capitalisation.

TABLE 6
Example Benchmark Portfolio Constituents - Value Stocks
Value Stocks

| | Market Cap. |
|---|---|
| | US$ Billions |
| Sector/Company | (11 Feb 2005) |
| Consumer Discretionary (CD) | |
| McDonalds Corporation | 39.614 |
| Gannett Co. Inc. | 19.936 |
| General Motors | 16.659 |
| May Department Stores | 10.942 |
| Johnson Controls Inc. | 10.641 |
| Eastman Kodak Co. | 9.435 |
| Consumer Staples (CS) | |
| Costco Wholesale Co. | 22.058 |
| CVS Corporation | 20.851 |
| General Mills Inc. | 17.973 |
| Archer Daniels Midlands | 14.228 |
| Conagra Food Inc | 13.841 |
| Reynolds American | 11.81 |
| Industrials (IND) | |
| Honeywell International Inc. | 31.972 |
| Fedex Corp. | 27.494 |
| Burlington N Sante | 19.709 |
| Union Pacific | 17.748 |
| Dover Corp. | 7.681 |
| RR Donnelley Sons | 6.755 |
| Health Care (HC) | |
| Cardinal Health Inc | 24.078 |
| HCA Inc. | 23.798 |
| Cigna CP | 11.884 |
| McKesson Corp. | 11.262 |
| Chiron Corp. | 7.062 |
| Laboratory Corp. | 6.682 |
| Tenet Healthcare Corp. | 5.531 |
| Mylan Labs Inc. | 4.698 |
| Thermo Electron Corp. | 3.987 |
| Watson Pharmaceuticals | 3.491 |
| Information Technology (IT) | |
| Motorola Inc. | 37.247 |
| Xerox Corp. | 14.303 |
| Sun Microsystems Inc. | 13.883 |
| Electronic Data Systems | 10.643 |
| KLA-Tencor Corp. | 8.831 |
| Computer Sciences Corp. | 8.718 |
| Micron Technology | 6.261 |
| Comverse Tech. Inc. | 4.953 |

TABLE 7
Example Benchmark Portfolio Constituents - Growth Stocks
Growth Stocks

| | Market Cap. |
|---|---|
| | US$ Billions |
| Sector/Company | (11 Feb 2005) |
| Consumer Discretionary (CD) | |
| Lowes Companies | 42.423 |
| Nike Inc. | 21.735 |
| Starbucks Corp. | 19.389 |
| Gap Inc. | 18.390 |
| Mattel Inc | 8.688 |
| Consumer Staples (CS) | |
| Colgate Palmolive | 28.121 |
| Kellogg Co. | 17.942 |
| Heinz H J Co. | 12.893 |
| Gillette Co. | 51.698 |
| Industrials (IND) | |
| Boeing Co. | 48.600 |
| Caterpillar Inc. | 30.983 |
| Lockheed Martin Corp. | 27.138 |
| Health Care (HC) | |
| Bristol Myers Sqibb | 49.380 |
| Guidant Corp. | 24.101 |
| Forest Labs CL A | 11.571 |
| Gilead Sciences | 16.700 |
| Information Technology (IT) | |
| Yahoo Inc. | 48.218 |
| First Data Corp. | 31.330 |
| Maxim Integrated | 13.510 |
| Paychex Inc. | 12.114 |

Table 8 shows the total market capitalisation of the example benchmark portfolio is US $1.06 trillion, split between the value and growth stocks.

TABLE 8
Example Benchmark Portfolio characteristics

| | | As a % of Portfolio |
|---|---|---|
| Style | US$ 000s | M. Cap. |
| Growth Stocks M. Cap | 526,659,000 | 49.61% |
| Growth Stocks M. Cap | 534,923,000 | 50.39% |
| Total M. Cap | 1,061,582,000 | 100.00% |

Table 9 shows the investment each of the ten investors has made on an average in the example benchmark portfolio. The growth and value percentage in Table 9 were calculated as follows:
Column 3=Value %=(Average(Ivₜ,Iv₍ₜ₋₁₎,Iv₍ₜ₋₂₎ . . . Iv₁))/B_{mc})*100
Column 5=Growth %=(Average(Igₜ,Ig₍ₜ₋₁₎,Ig₍ₜ₋₂₎ . . . Igₜ))/B_{mc})*100
Column 6=Value component=(Avg. investment in Value Stocks/Avg. investment in the example benchmark portfolio)*100
Column 6=Growth component=(Avg. investment in Growth Stocks/Avg. investment in the example benchmark portfolio)*100

TABLE 9
Value-Growth Split for 10 U.S. Investors

| | | | | | Value- |
|---|---|---|---|---|---|
| | | As a % of | | As a % of | Growth |
| | Avg. Value | the | Avg. Growth | the | Split |
| Investor | (US$000) | Portfolio | (US$000) | Portfolio | (%) |
| American Century | 72,468.69 | .00683% | 109,654.16 | .01033% | 40-60 |
| Investment Mgmt. (NY) | | | | | |
| Brandes Investment Partners, | 265,343.83 | .02500% | 289,307.00 | .02725% | 48-52 |
| LLC | | | | | |
| Capital Guardian Trust | 55,046.56 | .00519% | 126,686.34 | .01193% | 30-70 |
| Company | | | | | |
| Capital Research & | 537,531.33 | .05063% | 800,097.85 | .07537% | 40-60 |
| Management Company | | | | | |
| Dodge & Cox | 408,350.69 | .03847% | 135,450.11 | .01276% | 75-25 |
| Lazard Asset Management | 11,955.92 | .00113% | 29,936.19 | .00282% | 29-71 |
| (US) | | | | | |
| OppenheimerFunds, Inc. | 67,947.21 | .00640% | 86,593.29 | .00816% | 44-56 |
| Teacher Retirement System | 63,060.39 | .00594% | 73,189.13 | .00689% | 46-54 |
| of Texas | | | | | |
| Tweedy, Browne Company, | 38,160.71 | .00359% | 28,699.07 | .0027% | 57-43 |
| L.L.C. | | | | | |
| Wellington Management | 189,623.39 | .01786% | 209,517.70 | .01974% | 48-52 |
| Company, LLP | | | | | |

Column 2 and 4 in Table 9 shows the average investment in U.S. dollars in growth and value stocks for each of the ten investors. Columns 3 and 5 show the investment in value and growth stock as a percentage the example benchmark portfolio's total market capitalisation. Column 6 shows the value-growth split for each of the investors. For instance, Capital Guardian Trust Company exhibits a 30% investment in value stocks and 70% investment in growth stocks while American Century Investment Management (NY) invest in 40-60 ratio based on historical portfolio filings. This identifies and quantifies the investment style of the investors. Details in Table 9 are ordered in the alphabetical order of the investor name.

Tables 10 and 11 show the sector preference of each of the ten investors. While American Century Investment Management prefers to allocate more in Information Technology sector while investing in growth stocks, they prefer the Consumer Durables sector while investing in value stocks. Tables 10 and 11 show also show how this preference varies across investors. For instance, Tweedy, Brown and Company and Brandes Investment Partners do not invest in the industrial sector in either of the styles. This determines the potential investment percentage in Consumer Staples sector.

TABLE 10
Example Benchmark Portfolio - Sector weights for value stocks
Sector allocation in Value Stocks

| Investor | CD | CS | HC | IND | IT |
|---|---|---|---|---|---|
| American Century Investment | .032 | .006 | .009 | .016 | .006 |
| Mgmt. (NY) | | | | | |
| Brandes Investment Partners, LLC | .031 | .066 | .042 | .001 | .067 |
| Capital Guardian Trust Company | .004 | .019 | .003 | .010 | .016 |
| Capital Research & Management | .123 | .108 | .084 | .084 | .106 |
| Company | | | | | |
| Dodge & Cox | .073 | .000 | .076 | .095 | .101 |
| Lazard Asset Management (US) | .005 | .001 | .003 | .000 | .000 |
| OppenheimerFunds, Inc. | .029 | .016 | .009 | .008 | .007 |
| Teacher Retirement System of Texas | .027 | .010 | .007 | .009 | .009 |
| Tweedy, Browne Company, L.L.C. | .007 | .000 | | | .010 |
| Wellington Management Company, | .034 | .033 | .041 | .029 | .038 |
| LLP | | | | | |

TABLE 11
Example Benchmark Portfolio - Sector weights for growth stocks
Sector allocation in Growth stocks

| Investor | CD | CS | HC | IND | IT |
|---|---|---|---|---|---|
| American Century Investment | .018 | .012 | .024 | .010 | .032 |
| Mgmt. (NY) | | | | | |
| Brandes Investment Partners, LLC | .005 | .024 | .107 | .059 | |
| Capital Guardian Trust Company | .034 | .016 | .059 | .006 | .002 |
| Capital Research & Management | .190 | .091 | .213 | .161 | .089 |
| Company | | | | | |
| Dodge & Cox | .051 | .000 | .026 | .029 | .000 |
| Lazard Asset Management (US) | .005 | .005 | .001 | .007 | .010 |
| OppenheimerFunds, Inc. | .016 | .009 | .026 | .020 | .012 |
| Teacher Retirement System of Texas | .011 | .015 | .018 | .014 | .012 |
| Tweedy, Browne Company, L.L.C. | | .000 | .009 | | |
| Wellington Management Company, | .026 | .054 | .040 | .027 | .056 |
| LLP | | | | | |

Column 3 of Table 10 shows the sector weights for Consumer Staples sector for value stocks which matches Unilever's style and sector. Capital Research Management Company, Brandes and Wellington Management Company are the top three investors in value stocks in the Consumer Staples sector.

The value-growth percentage created in accordance with the principles of the present invention has immediate benefits. The company can use the value-growth percentage as a first level screening method to weed out those investors who are not interested in the style with which the company's stock is associated (for the example, Unilever's is currently a value stock). Since the example started with investors who already held Unilever stocks, it comes as no surprise that all of them invested in the Consumer Staples sector. A method of profiling investors of the present invention is not biased towards only those investors who have invested in Unilever stocks historically and is relevant in ascertaining the investment style of potential investors as well. The screening can be taken a level further by examining the sector weights (see Tables 10 and 11) of the different investors in the sector in which the company is associated. This helps the company focus more on those investors who participate actively in its sector, thereby saving considerable time and resources. For example, if Unilever were to conduct this analysis, it would focus on the Consumer Staples (CS) column in Table 10 as its stocks are currently regarded as value.

The value-growth split also enables the company to define several style brackets in which to categorise the investor. Since Unilever stocks are regarded as value stocks, Unilever can create categories of investors roughly based on their value-growth investment style such as for example a low priority investor (e.g. 30% value-70% growth); a low mid priority investor (e.g. 50% value-50% growth); a high mid priority investor (e.g. 70% value-30% growth); and a high priority investor (e.g. above 70% in value stocks). In an environment where time and resources are limited, the priorities can be used to define the most cost-effective channel of communication. By way of example, the company receives calls from investors and analysts asking for information, clarification or requesting a meeting with Unilever's senior officers. For instance, low priority investors can be contacted via mass mailing lists while high priority investors would receive priority when Unilever accepts meeting requests. Time permitting, these investors can also get information packs emphasising certain indicators specific to their style. This allows the company to allocate its scarce resources and engage the right investor at the right time with the right story.

Taking the method of profiling investors of the present invention a level further, the company can rank its current and potential investors based on their (investor) sector weights in the company's sector. In Table 10, while Capital Research Management Company, Brandes Investment Partners, and Wellington Management Company are the top three investors in value stocks in the consumer staples sector based on their sector weights, care should be taken not to base the decisions solely on the sector weights. The sector weights, when converted into dollar value, as a percentage of the investor's equity under management, could give the company a more realistic picture. When this calculation is applied, the ranking of the ten investors in value stocks in Consumer Staples sector is set forth in Table 12:

TABLE 12
Potential Investment for 10 U.S. Investors

| | | | Potential |
|---|---|---|---|
| | Equity Under | | Investment |
| | Management | | in CS Sector |
| | (Billions of | | (Millions of |
| Investor | US$) | Sector % | US$) |
| Capital Research & Management Company | 361.318 | 0.05343 | 193.05 |
| Wellington Management Company, LLP | 227.983 | 0.01629 | 37.13 |
| Brandes Investment Partners, LLC | 38.894 | 0.03249 | 12.63 |
| Capital Guardian Trust Company | 53.597 | 0.00965 | 5.17 |
| OppenheimerFunds, Inc. | 61.499 | 0.00813 | 4.99 |
| Teacher Retirement System of Texas | 56.876 | 0.00477 | 2.71 |
| American Century Investment Mgmt. (NY) | 7.625 | 0.00295 | 0.22 |
| Lazard Asset Management (US) | 24.257 | 0.00057 | 0.13 |
| Dodge & Cox | 73.404 | 0.00005 | 0.03 |
| Tweedy, Browne Company, L.L.C. | 3.040 | 0.00003 | 0.91 |

Table 12 shows that the top three investors in value stocks in the Consumer Staples sector are Capital Research Management Company, Wellington Management Company, and Brandes Investment Partners. The second and the third position has been swapped between Brandes Investment Partners and Wellington Management company because the calculation now takes the size of the funds into account, a more realistic view as compared to any comparison purely based on the sector weights. Another interesting fact from Table 12 is that while Dodge & Cox's, with its equity under management around US $73 billion is ranked ninth in terms of its potential investment in Consumer Staples sector, Brandes Investment Partners, with an equity under management around US $39 billion, is ranked third. This demonstrates the more realistic approach the present invention can take, rather than solely relying on either equity under management or sector weights.

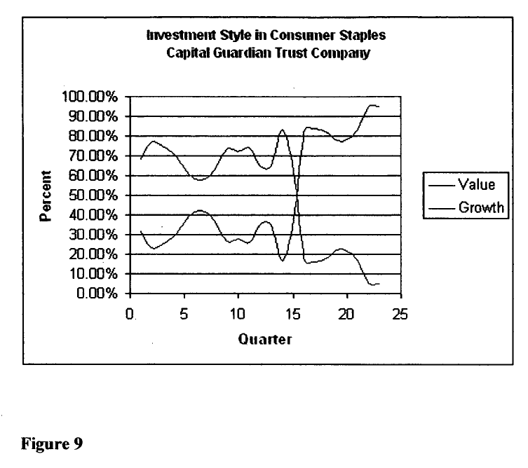

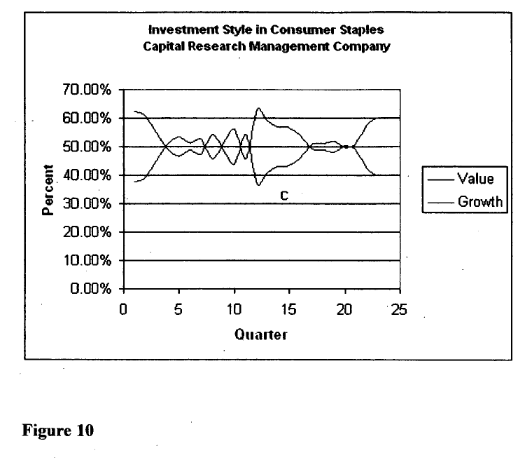

The present invention can be used as well to compare the changes to investment styles of different investors over time. For this, the process of the present invention is run for each quarter individually for each investor. In FIGS. 9 and 10, value-growth split in each of the last 24 quarters in Consumer Staples sector for Capital Guardian Trust Company and Capital Research Management Company is shown. It is evident from FIG. 9 that Capital Guardian has, in the recent quarters, preferred to invest more in value stocks and less in growth stocks where as Capital Research Management Company (FIG. 10) has generally been fluctuating in the 40%-60% range. This analysis is also useful in defining key performance indicators for the company by comparing the potential investment of the investor to the actual investment in Unilever Group asset on an ongoing basis.

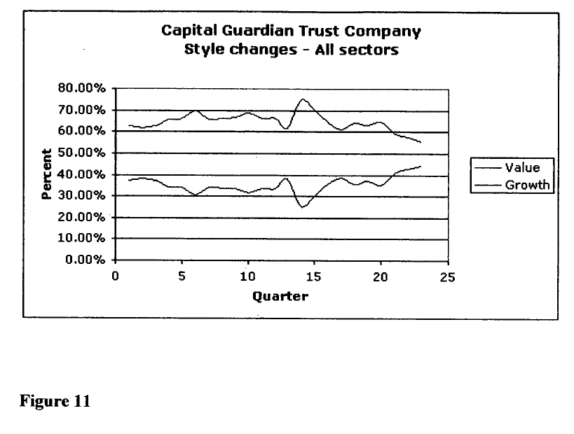

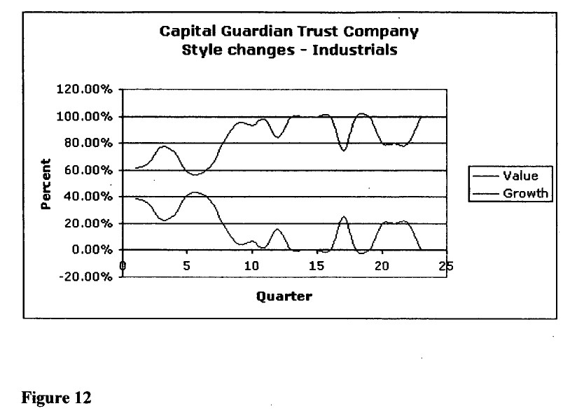

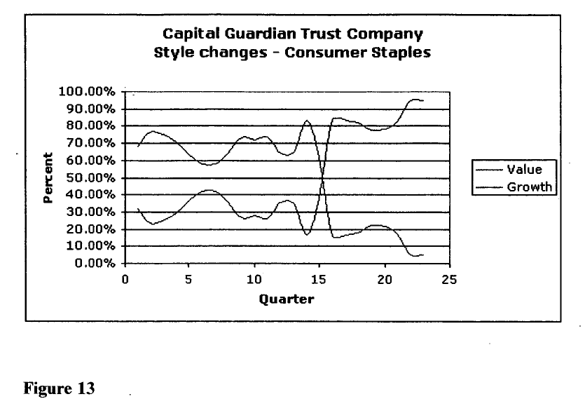

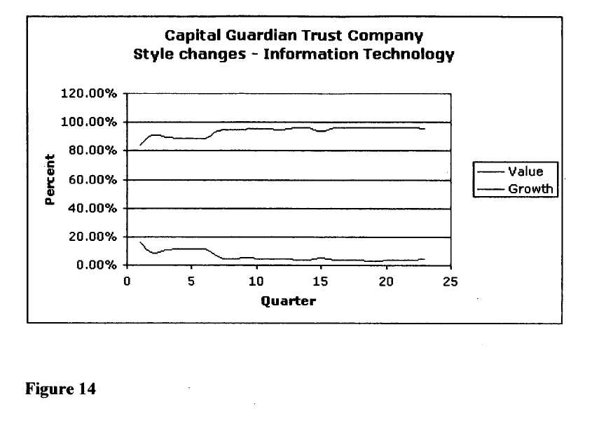

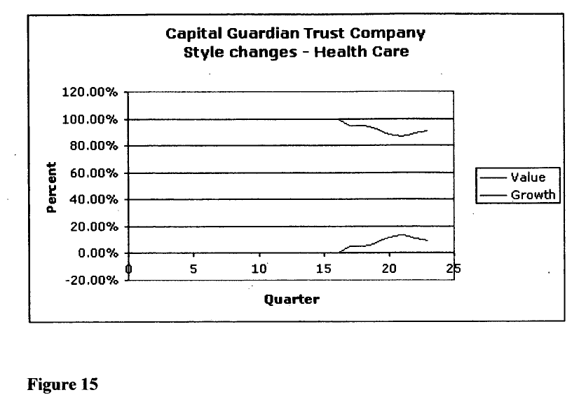

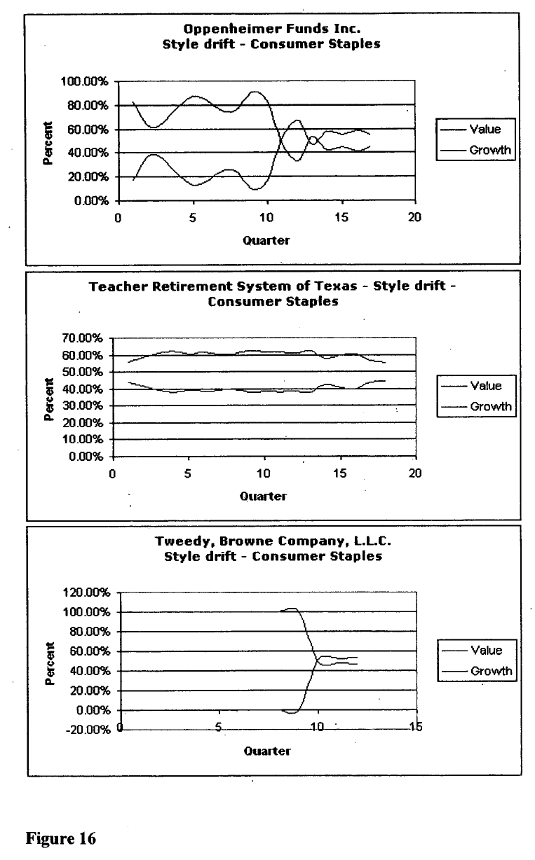

The present invention can also capture the changes to an investor's preference in different sectors over time. FIG. 11 shows that Capital Guardian Trust Company's overall value-growth style has remained more or less consistent between 70% Growth-30% Value during the past 24 quarters. Underneath this calm surface, there have been significant changes to Capital Guardian Trust Company's sector allocation strategies, as seen in FIGS. 12-15, where FIG. 12 shows an example style drift in the Industrials sector, FIG. 13 shows an example style drift in the Consumer Staples sector, FIG. 14 shows an example style drift in the Information Technology sector, and FIG. 15 shows an example style drift in the Health Care sector. From FIGS. 12-15, it can be seen that during the past 24 quarters, some sectors had experienced significant style changes such as the Industrials and Consumer Staples sectors while others such as Information Technology and Health Care have seen very little fluctuations. FIG. 16 shows the style drifts of key U.S. investors in Consumer Staples sector.

In an additional embodiment of the present invention, the benchmark pseudo portfolio could be populated with the complete set of companies from an index, for example the S&P 500®, based on S&P Barra Value and S&P Growth indices. When the process of the present invention is run based on the above constituents for all investors (current and potential), an index of investors can be created that could prove of immense value to any company listed in that index. This would provide the companies a growth index of investors and a value index of investors. This would further enable companies to target investors who match the style with which their stocks are associated. Using the sector weights, a similar sector index for value and growth investors can be created for each sector, similar to S&P's sector ranking. The above two indexes would provide companies with a readily available benchmark and fill a much-needed void for companies. By recreating the benchmark index every six months to coincide with the rebalancing of S&P indexes, the resulting value-growth style ratio eliminates the errors of misclassification when a S&P moves a constituent company from one Style to another.

Thus, the present invention provides a more realistic view in understanding the behaviour of investors and arriving at the potential investment value. Use of the present invention will assist companies in getting more value for the time and money spent by identifying and focusing on those investors who matter most. The present invention also can serve a wider purpose by providing a benchmark index of institutional investors to any listed company.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A method of profiling investors comprising:
identifying key investors;
collecting the portfolio of stocks held by each of these key investors;
creating a pseudo portfolio to see how an investor has behaved given a choice between different categories of stocks;
filtering the investor's historical portfolio through the pseudo portfolio; and
slicing the aggregate between the different categories of stocks.

2. The method of profiling investors of claim 1 further including identifying key investors based on based on the size and length of the investors' equity under management.

3. The method of profiling investors of claim 1 further including creating a pseudo portfolio based on different categories of stocks and industry sectors to see how an investor has behaved given a choice between different categories of stocks.

4. The method of profiling investors of claim 1 further including filtering the investor's historical portfolio through the pseudo portfolio by comparing the companies held in the investor's portfolio to the companies in the pseudo portfolio.

5. The method of profiling investors of claim 1 further including slicing the aggregate between the different categories of stocks by calculating an arithmetic mean of an aggregated dollar value invested by each investor in between the different categories of stocks in the pseudo portfolio.

6. The method of profiling investors of claim 5 further including converting the arithmetic mean of an aggregated dollar value invested by each investor in between the different categories of stocks in the pseudo portfolio into a percentage of total market capitalisation of the pseudo portfolio.

7. The method of profiling investors of claim 1 further including creating a pseudo portfolio to see how an investor has behaved given a choice between a value and a growth stock.

8. The method of profiling investors of claim 7 further including calculating a value percentage in accordance with:
Value %=(Average(Ivₜ,Iv₍ₜ₋₁₎,Iv₍ₜ₋₂₎ . . . Iv₍₁₎/B_{mc})*100
where B_{mc} is the total market capitalisation of all the stocks included in the benchmark pseudo portfolio; Ivₜ, Iv₍ₜ₋₁₎, Iv₍ₜ₋₂₎ . . . Iv₍₁₎ are the dollar value of the investments investor (Iv) has invested in the benchmark pseudo portfolio in value stocks in each quarter starting from now (t) to the first available quarter; and v stands for value stocks.

9. The method of profiling investors of claim 8 further including calculating a value component in accordance with:
Value component=(Avg. investment in Value Stocks/Avg. investment in the example benchmark portfolio)*100.

10. The method of profiling investors of claim 7 further including calculating a growth percentage in accordance with:
Growth %=(Average(Igₜ,Ig₍ₜ₋₁₎,Ig₍ₜ₋₂₎ . . . Ig₍₁₎))/B_{mc})*100
where B_{mc} is the total market capitalisation of all the stocks included in the benchmark pseudo portfolio; Igₜ, Ig₍ₜ₋₁₎, Ig₍ₜ₋₂₎ . . . Ig₍₁₎ are the dollar value of the investments investor (Ig) has invested in the benchmark pseudo portfolio in growth stocks in each quarter starting from now (t) to the first available quarter; and g stands for growth stocks.

11. The method of profiling investors of claim 10 further including calculating a growth component in accordance with:
Growth component=(Avg. investment in Growth Stocks/Avg. investment in the example benchmark portfolio)*100.

12. The method of profiling investors of claim 1 further including creating a benchmark index of institutional investors.

13. A method of profiling an investor comprising:
collecting the portfolio of stocks held by an investor;
generating a dilemma to the investor in selecting between stocks in different categories;
determining how the investor has behaved given a choice between stocks in different categories;
determining the preference of the investor with respect to the different categories of stocks;
filtering the investor's historical portfolio through the pseudo portfolio; and
slicing the aggregate between the different categories of stocks;

14. The method of profiling an investor of claim 13 further including identifying key investors based on the size and length of the investors' equity under management.

15. The method of profiling an investor of claim 13 further wherein generating a dilemma to the investor in selecting between stocks in different categories comprises creating a pseudo portfolio based on different categories of stocks and industry sectors.

16. The method of profiling an investor of claim 15 further including filtering the investor's historical portfolio through the pseudo portfolio by comparing the companies held in the investor's portfolio to the companies in the pseudo portfolio.

17. The method of profiling an investor of claim 13 further including slicing the aggregate between the different categories of stocks by calculating an arithmetic mean of an aggregated dollar value invested by each investor in between the different categories of stocks in the pseudo portfolio.

18. The method of profiling an investor of claim 17 further including converting the arithmetic mean of an aggregated dollar value invested by each investor in between the different categories of stocks in the pseudo portfolio into a percentage of total market capitalisation of the pseudo portfolio.

19. The method of profiling an investor of claim 13 further including generating a dilemma to the investor in selecting between a value and a growth stock.

20. The method of profiling an investor of claim 19 further including calculating a value percentage in accordance with:
Value %=(Average(Ivₜ,Iv₍ₜ₋₁₎,Iv₍ₜ₋₂₎ . . . Iv₍₁₎))/B_{mc})*100
where B_{mc} is the total market capitalisation of all the stocks included in the benchmark pseudo portfolio; Ivₜ, Iv₍ₜ₋₁₎, Iv₍ₜ₋₂₎ . . . Iv₍₁₎are the dollar value of the investments investor (Iv) has invested in the benchmark pseudo portfolio in value stocks in each quarter starting from now (t) to the first available quarter; and v stands for value stocks.

21. The method of profiling an investor of claim 20 further including calculating a value component in accordance with:
Value component=(Avg. investment in Value Stocks/Avg. investment in the example benchmark portfolio)*100.

22. The method of profiling an investor of claim 19 further including calculating a growth percentage in accordance with:
Growth %=(Average(Igₜ,Ig₍ₜ₋₁₎,Ig₍ₜ₋₂₎ . . . Ig₍₁₎))/B_{mc})*100
where B_{mc} is the total market capitalisation of all the stocks included in the benchmark pseudo portfolio; Igₜ, Ig_{(t-1), Ig}₍ₜ₋₂₎ . . . Ig₍₁₎ are the dollar value of the investments investor (Ig) has invested in the benchmark pseudo portfolio in growth stocks in each quarter starting from now (t) to the first available quarter; and g stands for growth stocks.

23. The method of profiling an investor of claim 22 further including calculating a growth component in accordance with:
Growth component=(Avg. investment in Growth Stocks/Avg. investment in the example benchmark portfolio)*100.

24. The method of profiling investors of claim 13 further including creating a benchmark index of institutional investors.

25. A method of profiling an investor comprising:
collecting the portfolio of stocks held by an investor;
creating a pseudo portfolio to see how the investor has behaved given a choice between a value stock and a growth stock;
filtering the investor's historical portfolio through the pseudo portfolio; and
slicing the aggregate between a value and growth stocks.

26. The method of profiling an investor of claim 25 further including identifying key investors based on based on the size and length of the investors' equity under management.

27. The method of profiling an investor of claim 25 further including creating a pseudo portfolio based on value and growth stocks and industry sectors to see how an investor has behaved given a choice between value and growth stocks.

28. The method of profiling an investor of claim 25 further including filtering the investor's historical portfolio through the pseudo portfolio by comparing the companies held in the investor's portfolio to the companies in the pseudo portfolio.

29. The method of profiling an investor of claim 25 further including slicing the aggregate between the different categories of stocks by calculating an arithmetic mean of an aggregated dollar value invested by each investor in between value and growth stocks in the pseudo portfolio.

30. The method of profiling an investor of claim 29 further including converting the arithmetic mean of an aggregated dollar value invested by each investor in between value and growth stocks in the pseudo portfolio into a percentage of total market capitalisation of the pseudo portfolio.

31. The method of profiling an investor of claim 25 further including calculating a value percentage in accordance with:
Value %=(Average(Ivₜ,Iv₍ₜ₋₁₎,Iv₍ₜ₋₂₎ . . . Iv₍₁₎))/B_{mc})*100
where B_{mc} is the total market capitalisation of all the stocks included in the benchmark pseudo portfolio; Ivₜ, Iv₍ₜ₋₁₎, Iv₍ₜ₋₂₎ . . . Iv₍₁₎ are the dollar value of the investments investor (Iv) has invested in the benchmark pseudo portfolio in value stocks in each quarter starting from now (t) to the first available quarter; and v stands for value stocks.

32. The method of profiling an investor of claim 31 further including calculating a value component in accordance with:
Value component=(Avg. investment in Value Stocks/Avg. investment in the example benchmark portfolio)*100.

33. The method of profiling an investor of claim 25 further including calculating a growth percentage in accordance with:
Growth %=(Average(Igₜ,Ig₍ₜ₋₁₎,Ig₍ₜ₋₂₎ . . . Ig₍₁₎))/B_{mc})*100
where B_{mc} is the total market capitalisation of all the stocks included in the benchmark pseudo portfolio; Igₜ, Ig₍ₜ₋₁₎, Ig₍ₜ₋₂₎ . . . Ig₍₁₎ are the dollar value of the investments investor (Ig) has invested in the benchmark pseudo portfolio in growth stocks in each quarter starting from now (t) to the first available quarter; and g stands for growth stocks.

34. The method of profiling an investor of claim 33 further including calculating a growth component in accordance with:
Growth component=(Avg. investment in Growth Stocks/Avg. investment in the example benchmark portfolio)*100.

35. The method of profiling investors of claim 25 further including creating a benchmark index of institutional investors.
